(19) United States
(12) Patent Application Publication
(10) Pub. No.: US 2026/0040235 A1
(43) Pub. Date: Feb. 5, 2026

(54) POWER CONTROL TECHNIQUES FOR RANDOM ACCESS CHANNEL REPETITIONS IN FULL DUPLEX NETWORKS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US); Hung Dinh LY, San Diego, CA (US)

(21) Appl. No.: 18/791,916

(22) Filed: Aug. 1, 2024

(51) Int. Cl. H04W 52/36; H04W 74/0833

(52) U.S. Cl. CPC H04W 52/367; H04W 74/0833

(57) ABSTRACT

Methods, systems, and devices for wireless communications are described. A user equipment (UE) may receive one or more messages that include an indication of a power offset to apply to one or more transmission powers associated with random access channel (RACH) communications. The UE may transmit, at a first slot associated with a first slot type (such as a time division duplex (TDD) slot), a first RACH repetition in accordance with a first transmission power associated with the first slot type, and may transmit, at a second slot associated with a second slot type that is different from the first slot type (such as a subband full duplex (SBFD) slot), a second RACH repetition in accordance with a second transmission power. In some aspects, the second transmission power may be associated with the second slot type, and may be based on a power offset applied to the first transmission power.

### FIELD OF TECHNOLOGY

The following relates to wireless communications, including power control techniques for random access channel (RACH) repetitions in full duplex networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more messages that include an indication of a power offset to apply to one or more transmission powers associated with random access channel (RACH) communications in one or more slot types, transmitting, at a first slot associated with a first slot type, a first RACH repetition in accordance with a first transmission power associated with the first slot type, and transmitting, at a second slot associated with a second slot type that is different from the first slot type, a second RACH repetition in accordance with a second transmission power associated with the second slot type, where the second transmission power is based on the power offset being applied to the first transmission power.

A UE for wireless communications is described. The UE may include one or more memories storing processor executable code, and one or more processors coupled with the one or more memories. The one or more processors may individually or collectively be operable to execute the code to cause the UE to receive one or more messages that include an indication of a power offset to apply to one or more transmission powers associated with RACH communications in one or more slot types, transmit, at a first slot associated with a first slot type, a first RACH repetition in accordance with a first transmission power associated with the first slot type, and transmit, at a second slot associated with a second slot type that is different from the first slot type, a second RACH repetition in accordance with a second transmission power associated with the second slot type, where the second transmission power is based on the power offset being applied to the first transmission power.

Another UE for wireless communications is described. The UE may include means for receiving one or more messages that include an indication of a power offset to apply to one or more transmission powers associated with RACH communications in one or more slot types, means for transmitting, at a first slot associated with a first slot type, a first RACH repetition in accordance with a first transmission power associated with the first slot type, and means for transmitting, at a second slot associated with a second slot type that is different from the first slot type, a second RACH repetition in accordance with a second transmission power associated with the second slot type, where the second transmission power is based on the power offset being applied to the first transmission power.

A non-transitory computer-readable medium storing code for wireless communications is described. The code may include instructions executable by one or more processors to receive one or more messages that include an indication of a power offset to apply to one or more transmission powers associated with RACH communications in one or more slot types, transmit, at a first slot associated with a first slot type, a first RACH repetition in accordance with a first transmission power associated with the first slot type, and transmit, at a second slot associated with a second slot type that is different from the first slot type, a second RACH repetition in accordance with a second transmission power associated with the second slot type, where the second transmission power is based on the power offset being applied to the first transmission power.

In some examples of the method, UEs, and non-transitory computer-readable medium described herein, receiving the one or more messages that include the indication of the power offset may include operations, features, means, or instructions for receiving the indication of the power offset to apply to the one or more transmission powers via a system information block message, a radio resource control (RRC) message, or both.

In some examples of the method, UEs, and non-transitory computer-readable medium described herein, the power offset being applied to the first transmission power includes a fixed power offset value.

In some examples of the method, UEs, and non-transitory computer-readable medium described herein, the first transmission power may be less than or equal to a first maximum transmission power associated with the first slot type, and the second transmission power may be less than or equal to a second maximum transmission power associated with the second slot type.

In some examples of the method, UEs, and non-transitory computer-readable medium described herein, the first transmission power may be based on a maximum transmission power associated with the first slot type, a number of RACH repetitions transmitted by the UE, and a pathloss factor, and the second transmission power may be based on the maximum transmission power associated with the first slot type, the number of RACH repetitions transmitted by the UE, the pathloss factor, and the power offset.

In some examples of the method, UEs, and non-transitory computer-readable medium described herein, a value of the power offset applied to the first transmission power may be based on a total quantity of RACH repetitions associated with both the first slot type and the second slot type, a quantity of RACH repetitions allocated to the first slot type, a quantity of RACH repetitions allocated to the second slot type, a reference signal receive power range associated with a received synchronization signal block (SSB), or any combination thereof.

Some examples of the method, UEs, and non-transitory computer-readable medium described herein may further include operations, features, means, or instructions for calculating a value of the power offset in accordance with an initial offset value and a slope value multiplied by a quantity of RACH repetitions.

Some examples of the method, UEs, and non-transitory computer-readable medium described herein may further include operations, features, means, or instructions for adjusting the first transmission power to be within a threshold transmission power, where the threshold transmission power includes a maximum transmission power of the second slot type plus the power offset.

Some examples of the method, UEs, and non-transitory computer-readable medium described herein may further include operations, features, means, or instructions for transmitting, at a third slot associated with the first slot type, the second RACH repetition based on a maximum power being reached for the second RACH repetition in the second slot.

Some examples of the method, UEs, and non-transitory computer-readable medium described herein may further include operations, features, means, or instructions for transmitting, at a third slot associated with the second slot type, a third RACH repetition based on a power restriction being reached for the first slot.

Some examples of the method, UEs, and non-transitory computer-readable medium described herein may further include operations, features, means, or instructions for increasing a repetition number associated with the RACH communications based on a power restriction being reached for the first slot or the second slot.

In some examples of the method, UEs, and non-transitory computer-readable medium described herein, the first RACH repetition and the second RACH repetition include at least a portion of a repetition group and the method, apparatuses, and non-transitory computer-readable medium may include further operations, features, means, or instructions for transmitting each RACH repetition of the repetition group in accordance with a common transmission power, where the common transmission power may be equal to a minimum transmission power between the first transmission power and the second transmission power.

In some examples of the method, UEs, and non-transitory computer-readable medium described herein, the first slot type includes a half-duplex slot and the second slot type includes a subband full-duplex (SBFD) slot, or the first slot type includes a SBFD slot and the second slot type includes a half-duplex slot.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support power control techniques for random access channel (RACH) repetitions in full duplex networks in accordance with one or more aspects of the present disclosure.

FIG. 3 shows an example of a power control transmission scheme that supports power control techniques for RACH repetitions in full duplex networks in accordance with one or more aspects of the present disclosure.

FIG. 4 shows examples of transmission power diagrams that support power control techniques for RACH repetitions in full duplex networks in accordance with one or more aspects of the present disclosure.

FIG. 5 shows an example of a process flow that supports power control techniques for RACH repetitions in full duplex networks in accordance with one or more aspects of the present disclosure.

FIGS. 6 and 7 show block diagrams of devices that support power control techniques for RACH repetitions in full duplex networks in accordance with one or more aspects of the present disclosure.

FIG. 8 shows a block diagram of a communications manager that supports power control techniques for RACH repetitions in full duplex networks in accordance with one or more aspects of the present disclosure.

FIG. 9 shows a diagram of a system including a device that supports power control techniques for RACH repetitions in full duplex networks in accordance with one or more aspects of the present disclosure.

FIGS. 10 and 11 show flowcharts illustrating methods that support power control techniques for RACH repetitions in full duplex networks in accordance with one or more aspects of the present disclosure.

### DETAILED DESCRIPTION

A user equipment (UE) may transmit one or more repetitions of random access channel (RACH) preambles to a network entity via a physical random access channel (PRACH) as part of a RACH procedure. The UE may perform the RACH procedure (such as a four-step RACH procedure) to obtain initial timing synchronization with the network entity, and to obtain a resource allocation for performing ongoing communications. In some aspects, the UE may transmit different RACH repetitions in different slots in order to reliably establish a connection with the network entity. For example, the UE may transmit RACH repetitions in time division duplex (TDD) or half-duplex slots, in subband full duplex (SBFD) slots or full-duplex slots, or a combination of both TDD and SBFD slots.

Network reception in TDD and SBFD slots, however, may be significantly different due to network self-interference in SBFD slots and a difference in receiving antenna panel size between different slot types at the network entity. For example, the network entity may utilize a full antenna panel to receive communications for TDD slots, and may dedicate half of the antenna panel to receive communications in SBFD slots. Thus, to accommodate these differences in network reception across the different slot types, the UE may transmit RACH repetitions with different transmission powers in TDD and SBFD slots. The network entity, the UE, or both, however, may lack knowledge of the different transmission powers used for transmitting RACH repetitions across different slot types, which may cause power divergence among other challenges.

In order to support efficient usage of both TDD and SBFD slots for RACH repetitions, the UE may support different power control regulation techniques for the transmission of RACH repetitions across different slot types (e.g., TDD and SBFD slot types). For example, the uplink power control for different slot types may be derived from an offset from the power control for RACH repetitions in the different respective slot types. For example, a first “baseline” power may be established for transmission of RACH repetitions in a TDD slot, and the power for transmission of RACH repetitions in SBFD slots may be determined by applying a power offset to the baseline power of the TDD slot. The power offset value may be based on various factors such as a total quantity of RACH repetitions transmitted, a quantity of RACH repetitions allocated for each of the TDD and SBFD slot types, a reference signal receive power (RSRP) range of a synchronization signal block (SSB) associated with RACH, among other factors. Additionally, or alternatively, the UE may support techniques to reduce the likelihood of power divergence for RACH transmissions in TDD and SBFD slots. For example, if the difference in transmission power between the TDD and SBFD slots is less than or greater than the power offset, the UE may adjust transmission power, increase the repetition quantity, or restrict to transmitting repetitions in slots of the same type.

Aspects of the disclosure may be implemented to realize one or more of the following possible advantages. In some aspects, support for power control for transmissions of RACH repetitions in both TDD and SBFD slots may allow for reduced RACH latency. For example, if a slot pattern includes a TDD slot followed by and SBFD slot, the UE may transmit RACH repetitions in the consecutive TDD and SBFD slots (rather than waiting for a next TTD or SBFD slot to transmit the next RACH repetition). The techniques described herein may also improve the efficiency of initial access performed by the UE, and may reduce the likelihood of power convergence between transmissions of RACH in different slot types.

Aspects of the disclosure are initially described in the context of wireless communications systems. Aspects of the disclosure are further illustrated by power control transmission schemes, transmission power diagrams, a process flow, and described with reference to apparatus diagrams, system diagrams, and flowcharts that relate to power control techniques for RACH repetitions in full duplex networks.

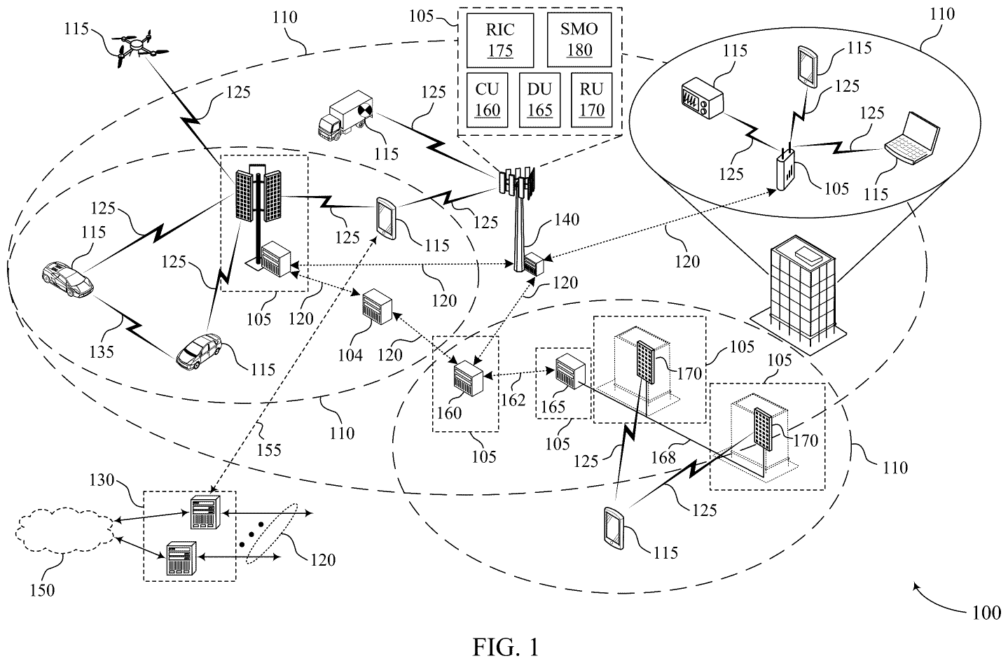

FIG. 1 shows an example of a wireless communications system 100 that supports power control techniques for RACH repetitions in full duplex networks in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Wireless devices in the wireless communications system 100 (including UEs 115 and network entities 105) may be capable of supporting both half-duplex and full-duplex communications. For example, if a UE 115 has a half-duplex capability, the UE 115 may transmit uplink communications in a time slot, or may receive downlink communications in a time slot (but may be barred from transmitting and receiving in a single time slot). Conversely, if the UE 115 has a full-duplex capability, the UE 115 may transmit both uplink communications and receive downlink communications in a single time slot. In some cases, the UE 115 may support SBFD capabilities, where a time division duplex (TDD) carrier or time slot is split into non-overlapping subbands including at least one uplink subband and at least downlink subband to enable simultaneous transmission and reception in the same slot. In some implementations, the network entity 105-a may indicate (e.g., via a semi-static or dynamic indication in RRC, system information signaling, or other signaling) one or more time locations, frequency locations, or both, of the SBFD subbands to the UE 115 while the UE 115 is in an RRC connected state. In some examples, the UE 115 may perform RACH in SBFD symbols (e.g., if the UE 115 is in RRC connected or RRC idle states). For example, the UE 115 may transmit one or more repetitions of a RACH preamble in SBFD symbols, and across both uplink and SBFD symbols. In some examples, the network entity 105 may transmit one or more RACH configurations that include an indication of RACH occasions configured in SBFD symbols.

A UE 115 may transmit one or more repetitions of RACH preambles to a network entity 105 via a PRACH as part of a RACH procedure. The UE 115 may perform the RACH procedure (such as a four-step RACH procedure) to obtain initial timing synchronization with the network entity 105, and to obtain a resource allocation for performing ongoing communications. In some aspects, the UE 115 may transmit different RACH repetitions in different slots in order to reliably establish a connection with the network entity. For example, the UE 115 may transmit RACH repetitions in time division duplex (TDD) slots, in subband full duplex (SBFD) slots, or a combination of both TDD and SBFD slots, among other slot types. Network reception in TDD and SBFD slots, however, may be significantly different due to network self-interference in SBFD slots and a smaller receiving panel usage at the network entity. To account for these differences in network reception across the different slot types, the UE 115 may transmit RACH repetitions with different transmission powers in TDD and SBFD slots.

In order to support efficient usage of both TDD and SBFD slots for RACH repetitions, the UE 115 may support different power control regulation techniques for the transmission of RACH repetitions across different slot types (e.g., TDD and SBFD slot types). For example, the uplink power control for different slot types may be derived from an offset from the power control for RACH repetitions in the different respective slot types. For example, a first “baseline” power may be established for transmission of RACH repetitions in a TDD slot, and the power for transmission of RACH repetitions in SBFD slots may be determined by applying a power offset to the baseline power of the TDD slot. Additionally, or alternatively, the UE may support techniques to reduce the likelihood of power divergence for RACH transmissions in TDD and SBFD slots.

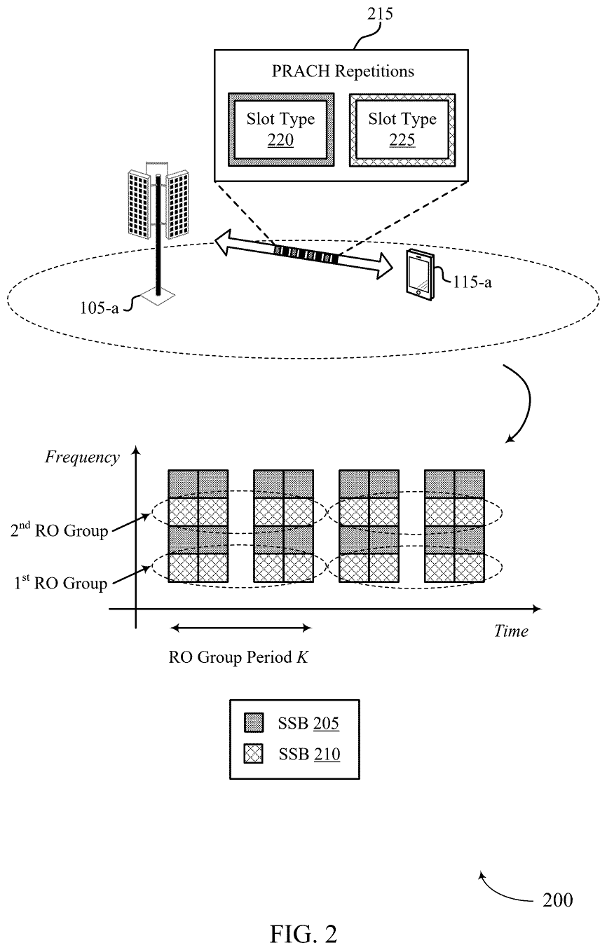

FIG. 2 shows an example of a wireless communications system 200 that supports power control techniques for RACH repetitions in full duplex networks in accordance with one or more aspects of the present disclosure. For example, the wireless communications system may support signaling between a UE 115-a and a network entity 105-a, each of which may be examples corresponding devices (e.g., UEs 115 and network entities 105) described with reference to FIG. 1.

In order to establish a connection with the network entity 105-a, the UE 115-a may perform synchronization for both uplink and downlink communications. For example, the UE 115-a may perform downlink synchronization by receiving and decoding one or more synchronization signal blocks (SSBs) transmitted by the network entity 105-a, and may perform uplink synchronization by performing a RACH procedure (e.g., a PRACH procedure, an initial access procedure). In some aspects, the UE 115-a may perform a four-step RACH procedure, including transmitting one or more repetitions of a RACH preamble (e.g., Msg1). The network entity 105-a may respond to the one or more repetitions of the RACH preamble with a RACH response (e.g., Msg2), including a random access preamble identifier, timing alignment information, an initial uplink grant for the UE 115-a, and cell-specific radio network temporary identifier (RNTI). The UE 115-a may then transmit a scheduled uplink transmission (e.g., Msg3) to the network entity 105-a, including an initial RRC connection setup and reestablishment, handover information, or other information. The network entity 105-a may then respond with a message (e.g., Msg4) which may mark the completion of the RACH procedure.

In some aspects, a RACH procedure for the UE 115-a may be triggered upon request of a PRACH transmission by higher layers of the wireless communications system 200, or by a physical downlink control channel (PDCCH) order for a cell (e.g., a cell associated with the network entity 105-a). In some implementations, the UE 115-a may receive (e.g., from the network entity 105-a or from higher layers) a configuration indicative of a PRACH transmission. In some examples, the configuration may include a configuration for PRACH transmission on the cell, a preamble index, a preamble subcarrier spacing (SCS), a target or threshold transmission power level for the PRACH transmission (e.g., P_{PRACH,target}), a corresponding random access-specific RNTI, and a PRACH resource for the cell. In addition, the configuration may include or indicate a quantity of RACH preamble repetitions

$$( e . g . , {N}_{preamble}^{rep} > 1 )$$

for the PKACH transmission, if the UE 115-a transmits the RACH preamble with repetition.

In some aspects, the UE 115-a may transmit the PRACH to the network entity 105-a using the selected PRACH format indicated by the configuration, with a transmission power (e.g., P_{PRACH,b,f,c}(i)), on the indicated PRACH resource. Additionally, or alternatively, if the UE 115-a transmits RACH preamble repetitions (e.g.,

$${N}_{preamble}^{rep}$$

repetitions) using a same spatial filter, the UE 115—may transmit the PRACH to the network entity 105-a on a determined set of resources (e.g.,

$$( e . g . , {N}_{preamble}^{rep} ) .$$

In some examples, for a PRACH transmission with a configured quantity of preamble repetitions (e.g.,

$${N}_{preamble}^{rep}$$

repetitions), a resource set for the configured quantity of repetitions (e.g.,

$${N}_{preamble}^{rep}$$

repetitions) may include valid PRACH occasions that are consecutive in time, use the same frequency resources, and are associated with same one or more SSBs, physical broadcast channel (PBCH) block indices, or both.

In some examples, one or more sets of valid PRACH occasions for each configured quantity of preamble repetitions may repeat according to a configured time duration. For example, the configured time duration may start from a first frame (e.g., frame 0), and may extend to include a smallest integer number of association pattern periods such that at least one set of valid PRACH occasions for each of the N_{Tx}^{SSB} SSB or PBCH block indices may be included within the time duration (for all configured quantity of preamble repetitions).

In some examples, each SSB or PBCH block index may be associated with identical preamble indexes in the valid PRACH occasions within the resource set. For example, the UE 115-a may be configured with different RACH occasion groups associated with different sets of SSBs (e.g., SSB 205, SSB 210) for transmission of repetitions of the RACH preambles. In some aspects, the RACH occasion groups may include a set of

$${N}_{preamble}^{rep}$$

valid PRACH occasions that are consecutive in time and occupy the same frequency resources. For example, if the UE 115-a is configured to transmit a quantity of PRACH preamble repetitions (e.g., N=4 PRACH repetitions, although other integer numbers of repetitions are possible), each RACH occasion may include two SSBs (e.g., SSB 205 and SSB 210), and each RACH occasion group may include four frequency division multiplexed RACH occasions. In such examples, the RACH occasion group has may include four valid RACH occasions (e.g., N=2) for transmission of four RACH repetitions (or other quantities of valid RACH occasions for transmission of respective quantities of RACH repetitions).

In some aspects, the UE 115-a may transmit PRACH repetitions 215 in different slots (e.g., consecutive slots or non-consecutive slots) in order to reliably establish a connection with the network entity 105-a. For example, the UE 115-a may transmit PRACH repetitions 215 in TDD slots or half-duplex slots (e.g., a first slot type 220), in SBFD slots (e.g., a second slot type 225), or a combination of both TDD and SBFD slots. For example, if a UE 115-a has a half-duplex capability, the UE 115-a may transmit uplink communications in a time slot, or may receive downlink communications in a time slot (but may be barred from transmitting and receiving in a single time slot). Additionally, or alternatively, if the UE 115 has a full-duplex capability, the UE 115 may transmit both uplink communications and receive downlink communications in a single time slot. In some cases, the UE 115-a may support full-duplex capabilities (e.g., SBFD capabilities), where a TDD carrier or time slot is split into non-overlapping subbands including at least one uplink subband and at least downlink subband to enable simultaneous transmission and reception in the SBFD slot.

In some implementations, the UE 115-a may transmit PRACH repetitions 215 in TDD slots, SBFD slots, or a combination of both TDD and SBFD slots. For example, in order to reduce transmission latency of PRACH repetitions, the UE 115-a may form a RACH occasion group that includes both TDD and SBFD slots. In some aspects, however, network reception in TDD and SBFD slots may be significantly different due to network self-interference in SBFD slots and a smaller receiving panel usage at the network entity 105-a (e.g., the network entity 105-a uses one half of the antenna panel for receiving communications and one half of the antenna panel for transmitting communications in the SBFD slot, and uses the full antenna panel for either transmitting or receiving in a TDD slot). Thus, to mitigate these differences, the UE 115-a may transmit PRACH repetitions 215 with different transmission powers in TDD and SBFD slots (e.g., using a first transmission power for repetitions in TDD slots and a second transmission power for repetitions in SBFD slots) to accommodate for differences in network reception across the different slot types. The network entity 105-a may then identify or determine the power difference between the different slot types in order to effectively combine the PRACH repetitions 215 across the different slot types.

In some aspects, the UE 115-a may perform power control regulation for different slot types (e.g., TDD slots and SBFD slots) that the UE 115-a uses to transmit PRACH repetitions. The UE 115-a may determine a transmission power for a PRACH in a TDD slot, P_{PRACH,b,f,c}(i), on an active uplink bandwidth part b, of carrier f, of cell c, based on a downlink reference signal for cell c, in transmission occasion i, as:

$${P}_{PRACH , b , f , c} ( i ) = min \{ {P}_{CMAX , f , c} ( i ) , {P}_{PRACH , target , f , c} + {PL}_{b , f , c} \} [ dBm ] ,$$

where P_{CMAX,f,c}(i) is a UE-configured maximum output power for carrier f of cell c within transmission occasion i, P_{PRACH,target,f,c} is the PRACH target reception power (e.g., preamble received target power) provided by higher layers for the active uplink bandwidth part b of carrier f of cell c, and PL_{b,f,c} is a pathloss for the active uplink bandwidth part b of carrier f based on the downlink reference signal associated with the PRACH transmission on the active downlink bandwidth part of cell c and calculated by the UE 115-a.

For PRACH repetitions 215 that span different slot types (e.g., TDD and SBFD slots, a first slot type 220 and a second slot type 225), the UE 115-a may determine a transmission power for PRACH in an SBFD slot based on an offset from the PRACH transmission power of the TDD slot (or the UE 115-a may determine the PRACH transmission power of the TDD slot based on an offset from the transmission power of the SBFD slot). For example, the UE 115-a may support a first “baseline” power for transmission of PRACH repetitions in a TDD slot, may determine the transmission power for PRACH repetitions 215 in SBFD slots as the baseline power ((e.g., P_{PRACH,b,f,c}(i)) plus some power offset. The power offset value may be based on various factors such as a total number of PRACH repetitions transmitted, a number of PRACH repetitions allocated for each of the TDD and SBFD slot types, an RSRP range of an SSB associated with PRACH, among other factors. Additionally, or alternatively, the UE 115-a may support power control to reduce or eliminate the likelihood that the difference in power between RACH transmissions in TDD and SBFD slots is less than or greater than the power offset (which make cause a divergence of the transmission powers across different slot types at the network entity 105-a). For example, the UE 115-a may adjust the transmission power of a slot if the difference in power is less than or greater than the power offset, or the UE 115-a may increase a repetition number, or restrict transmission of repetitions to be in slots of the same slot type.

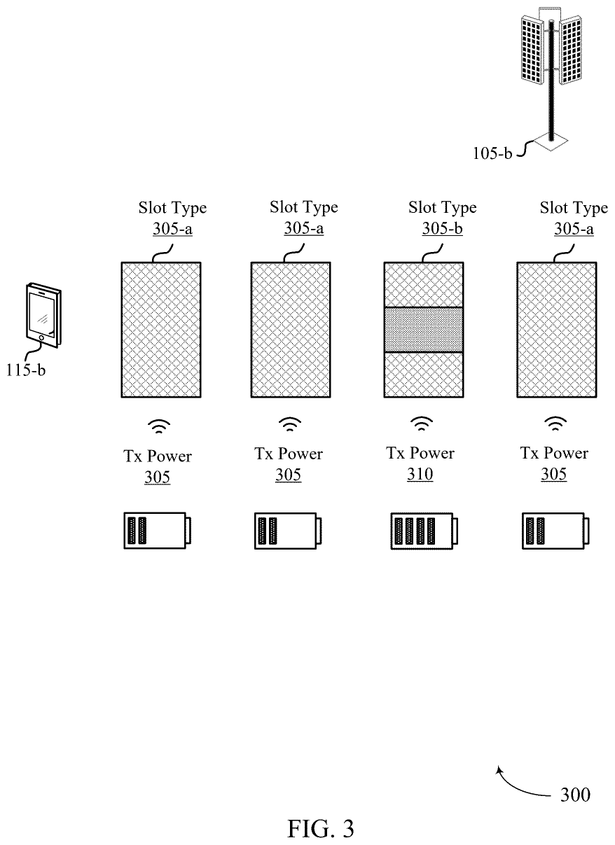

FIG. 3 shows an example of a power control transmission scheme 300 that supports power control techniques for RACH repetitions in full duplex networks in accordance with one or more aspects of the present disclosure. For example, the power control transmission scheme 300 may illustrate PRACH repetition transmission across different slot types by a UE 115-b to the network entity 105-b, which may be examples of UEs 115 and network entities described with reference to FIGS. 1 and 2.

In some aspects, the UE 115-b may perform power control regulation for different slot types such as slot type 305-a (which may be an example of a TDD slot) and a slot type 305-b (which may be an example of an SBFD slot) that the UE 115-b uses to transmit PRACH repetitions. The UE 115-b may determine a transmission power 305 for a PRACH in a TDD slot, P_{PRACH,b,f,c}(i), as:

$${P}_{PRACH , b , f , c} ( i ) = min \{ {P}_{CMAX , f , c} ( i ) , {P}_{PRACH , target , f , c} + {PL}_{b , f , c} \} [ dBm ] ,$$

where P_{CMAX,f,c}(i) is a UE-configured maximum output power for carrier f of cell c within transmission occasion i, P_{PRACH,target,f,c} is the PRACH target reception power (e.g., preamble received target power) provided by higher layers for the active uplink bandwidth part, and PL_{b,f,c} is a pathloss for the active uplink bandwidth part based on the downlink reference signal associated with the PRACH transmission on the active downlink bandwidth part and calculated by the UE 115-b.

For PRACH repetitions that span different slot types, including slot type 305-a and slot type 305-b (e.g., TDD and SBFD slots), the UE 115-b may determine a transmission power for PRACH in an SBFD slot based on an offset from the PRACH transmission power of the TDD slot. Additionally, or alternatively, the UE 115-b may determine the PRACH transmission power of the TDD slot based on an offset from the transmission power of the SBFD slot. For example, the UE 115-b may support a first “baseline” power for transmission of PRACH repetitions in a TDD slot (e.g., transmission power 305), may determine the transmission power for PRACH repetitions in SBFD slots (e.g., transmission power 310) as the baseline power ((e.g., P_{PRACH,b,f,c}(i)) plus some power offset. For example, the transmission power for PRACH repetitions in SBFD slots may be calculated as:

$${P}_{PRACH , b , f , c , SBFD} ( i ) = min \{ {P}_{CMAX , f , c , SBFD} ( i ) , {P}_{PRACH , b , f , c} ( i ) + {PL}_{b , f , c} + {Δ}_{SBFD , TDD} \} ,$$

where P_{CMAX,f,c}(i) is a UE-configured maximum output power for carrier f of cell c within transmission occasion i, P_{PRACH,b,f,c} is the PRACH target reception power (e.g., preamble received target power) provided by higher layers for the active uplink bandwidth part, and PL_{b,f,c} is a pathloss for the active uplink bandwidth part based on the downlink reference signal associated with the PRACH transmission on the active downlink bandwidth part and calculated by the UE 115-b, and Δ_{SBFD,TDD} is the configured offset from the determined transmission power in the TDD slot. In some examples, the UE 115-b may receive an indication of the power offset (e.g., via system information signaling such as system information block-1 (SIB1) signaling, or RRC signaling), or the power offset may be a fixed value. In such examples, the calculated transmission power of the SBFD slot may still be within a maximum power associated with the SBFD slot type.

In some implementations, the power offset value may be based on the quantity of repetitions allocated to the first slot type (e.g., the TDD slots) and the quantity of repetitions allocated to the second slot type (e.g., the SBFD slots). In some examples, the power offset value may be based or configured for a total quantity of SBFD repetitions transmitted by the UE 115-a (e.g., the power offset may increase or decrease based on the total quantity of SBFD repetitions). In some examples, the power offset may be based on an RSRP range of the SSB associated with the PRACH repetitions (e.g., the power offset may change based on an increase or decrease in the RSRP range). In some examples, the power offset value may be based on the quantity of repetitions in TDD slots and the quantity of repetitions in SBFD slots (e.g., the power offset may change based on the relative distribution of repetitions in different slot types). For example, if the UE 115-b transmits four PRACH repetitions and if one repetition is in an SBFD slot, the power offset may be set to 3 dB. Then, if two out of four repetitions are in SBFD slots, the power offset may be set to 4 dB, while three out of four repetitions in SBFD slots may have a power offset set to 5 dB, and four out of four repetitions in SBFD slots may have a power offset set to 6 dB.

In some other examples, the UE 115-b may calculate the power offset (Δ_{SBFD,TDD}) using an equation:

$${Δ}_{SBFD , TDD} = α + β \times num\_SBFD \_reps ,$$

where α is equal to a configured offset from zero, β is a configured slope value (e.g., which may be RRC configured or dynamically configured), and num_SBFD_reps is the quantity of PRACH repetitions in SBFD slots.

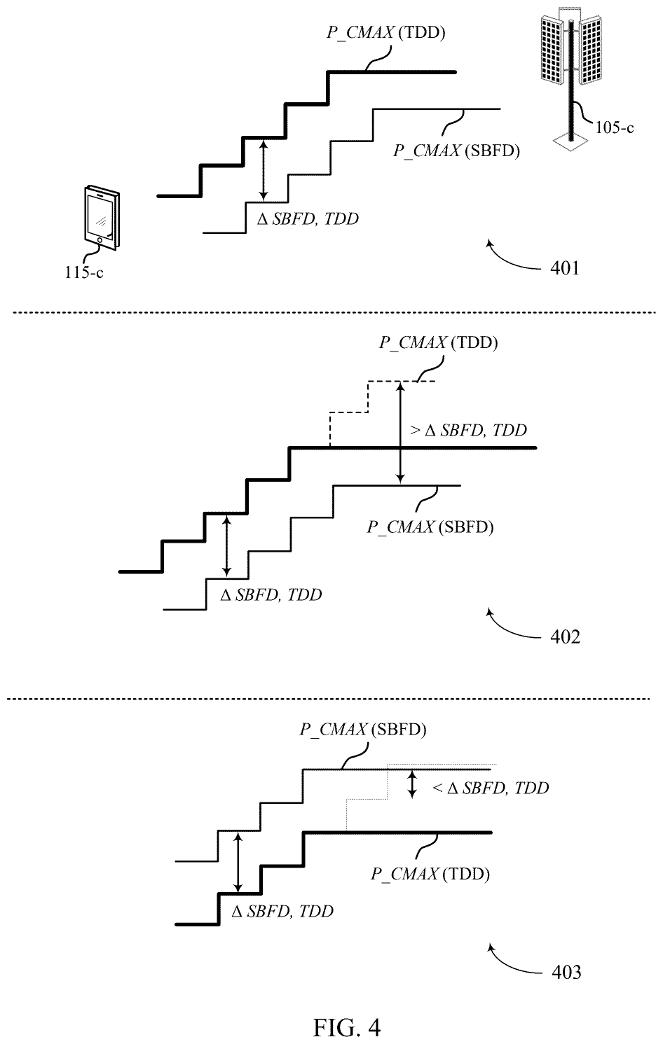

FIG. 4 shows example transmission power diagrams (e.g., transmission power diagram 401, transmission power diagram 402, and transmission power diagram 403) that support power control techniques for RACH repetitions in full duplex networks in accordance with one or more aspects of the present disclosure. For example, the transmission power diagram 401, the transmission power diagram 402, and the transmission power diagram 403 illustrate different transmission powers and power control processes performed by the UE 115-c to the network entity 105-c, which may be an example of UEs 115 and network entities 105 described with reference to FIGS. 1-3.

As illustrated in the transmission power diagram 401, the UE 115-c may transmit PRACH repetitions in a first slot type (e.g., a TDD slot type) and a second slot type (e.g., a SBFD slot type). For example, the UE 115-c may transmit a first repetition according to a first transmit power of the first slot type, and may gradually increase the transmit power of subsequent repetitions in increments until the maximum transmission power of the first slot type (e.g., P_{CMAX(TDD)}) is reached. The UE 115-c may also transmit repetitions according to a first transmit power of the second slot type, and may gradually increase the transmit power of subsequent repetitions in increments until the maximum transmission power of the second slot type (e.g., P_{CMAX(SBFD)}) is reached. In some examples, the difference in transmission power between the first slot type and the second slot type may be maintained at a threshold power difference (e.g., Δ_{SBFD,TDD}).

As illustrated in the transmission power diagram 402, the UE 115-c may in some cases diverge from the threshold power difference (e.g., Δ_{SBFD,TDD}) if the UE 115-c continues to increment or increase the power of the first slot type after a maximum power associated with the second slot type is reached. For example, the UE 115-c may continue to increase the power of the TDD slot such that the difference between transmission powers of the TDD slot and the SBFD slot exceeds the threshold power difference (e.g., the difference is >Δ_{SBFD,TDD}). In such examples, the UE 115-c may restrict the power of the TDD slot such that the threshold power difference (e.g., Δ_{SBFD,TDD}) is maintained.

As illustrated in the transmission power diagram 403, the UE 115-c may in some cases diverge from the threshold power difference (e.g., Δ_{SBFD,TDD}) if the UE 115-c continues to increment or increase the power of the first slot type after a maximum power associated with the second slot type is reached. For example, the UE 115-c may continue to increase the power of the TDD slot such that the difference between transmission powers of the TDD slot and the SBFD slot is less than the threshold power difference (e.g., the difference is <Δ_{SBFD,TDD}). In such examples, the UE 115-c may restrict the power of the TDD slot or the SBFD such that the threshold power difference (e.g., Δ_{SBFD,TDD}) is maintained.

In some other examples, the UE 115-c may restrict repetitions to repetitions occurring within slots of the same type (e.g., the UE 115-c may transmit repetitions in TDD slots or SBFD slots, but may restrict repetitions across both TDD and SBFD slots), or the UE 115-c may select a slot type that has not reached maximum power. In some other examples, the UE 115-c may increase the quantity of repetitions performed for the PRACH.

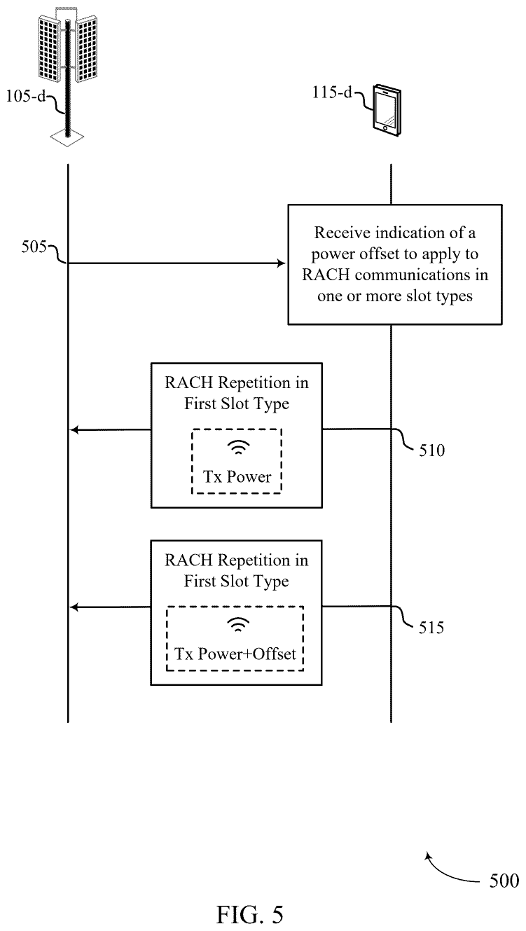

FIG. 5 shows an example of a process flow 500 that supports power control techniques for RACH repetitions in full duplex networks in accordance with one or more aspects of the present disclosure. For example, the process flow 500 illustrates communications between a UE 115-d (which may be an example a UE 115 described herein) and a network entity 105-d (which may be an example of a network entity 105 described herein).

Alternative examples of the following may be implemented. Some steps are performed in a different order than described herein or are not performed at all. In some implementations, steps may include additional features not mentioned below, or additional steps may be added. Further, although the UE 115-d and the network entity 105-d are shown performing the operations of the process flow 500, some aspects of some operations may also be performed by one or more other wireless communication devices.

At 505, the UE 115-d may receive (e.g., obtain, determine) one or more messages that include an indication of a power offset to apply to one or more transmission powers associated with RACH communications in one or more slot types. In some examples, the UE 115-d may receive the one or more messages via system information (e.g., a SIB message such as SIB1), one or more RRC messages, or both. In some examples, the power offset may be a fixed value configured for the UE 115-d. In some examples, the UE 115-d may calculate a value of the power offset to apply to the one or more transmission powers using an initial offset value and a slope value multiplied by a quantity of RACH repetitions that the UE 115-d will transmit.

At 510, the UE 115-d may transmit, at a first slot associated with a first slot type, a first RACH repetition in accordance with a first transmission power associated with the first slot type.

At 515, the UE 115-d may transmit, at a second slot associated with a second slot type that is different from the first slot type, a second RACH repetition in accordance with a second transmission power associated with the second slot type, where the second transmission power is based at least in part on the power offset being applied to the first transmission power.

In some implementations, the first transmission power may be less than or equal to a first maximum or threshold transmission power associated with the first slot type, and the second transmission power may be less than or equal to a second maximum or threshold transmission power associated with the second slot type. In some examples, the first transmission power may be based on a maximum transmission power associated with the first slot type, a number of RACH repetitions transmitted by the UE 115-d, and a pathloss factor. In such examples, the second transmission power may be based on the maximum transmission power associated with the first slot type, the number of RACH repetitions transmitted by the UE 115-d, the pathloss factor, and the power offset.

In some examples, a value of the power offset applied to the first transmission power is based on a total quantity of RACH repetitions associated with both the first slot type and the second slot type, a quantity of RACH repetitions allocated to the first slot type, a quantity of RACH repetitions allocated to the second slot type, an RSRP range associated with a received SSB, or any combination thereof. In some cases, the UE 115-d may adjust the first transmission power to be within a threshold transmission power equal to a maximum transmission power of the second slot type plus the power offset.

In some examples, the UE 115-d may transmit the second RACH repetition at a third slot associated with the first slot type based on the maximum power being reached for the second RACH repetition in the second slot. In some examples, the UE 115-d may transmit a third RACH repetition at a third slot associated with the second slot type based on a power restriction being reached for the first slot or the second slot.

In some examples, the first RACH repetition and the second RACH repetition include at least a portion of a repetition group, and the UE 115-d may transmit each RACH repetition of the repetition group in accordance with a common transmission power that is equal to a minimum power between the first transmission power and the second transmission power. For example, the UE 115-d may transmit over all RACH occasions in the repetition with a power that is equal to the minimum calculated transmission power across the different slot types. For example, for the first slot and the second slot each having the corresponding first and second transmission powers, the UE 115-d may transmit across each repetition with the same power that is equal to the minimum transmission power.

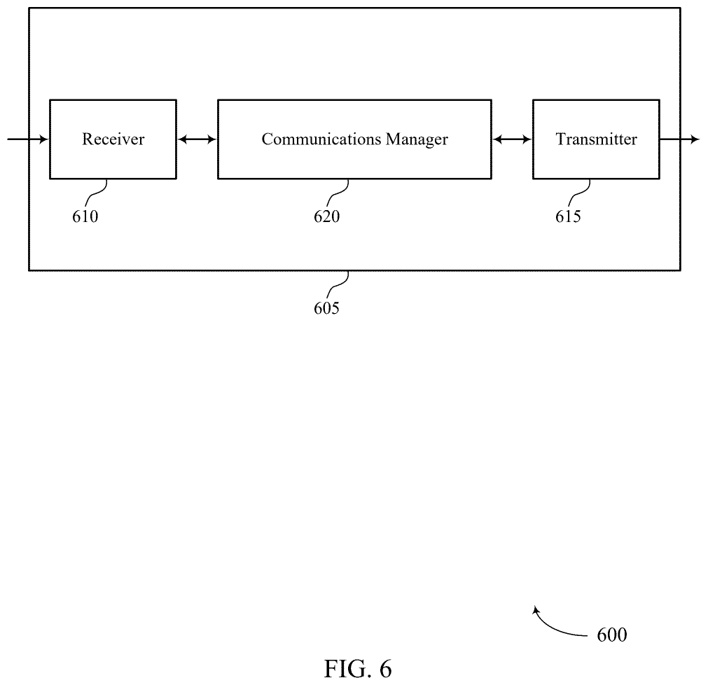

FIG. 6 shows a block diagram 600 of a device 605 that supports power control techniques for RACH repetitions in full duplex networks in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to power control techniques for RACH repetitions in full duplex networks). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power control techniques for RACH repetitions in full duplex networks). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of power control techniques for RACH repetitions in full duplex networks as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving one or more messages that include an indication of a power offset to apply to one or more transmission powers associated with RACH communications in one or more slot types. The communications manager 620 is capable of, configured to, or operable to support a means for transmitting, at a first slot associated with a first slot type, a first RACH repetition in accordance with a first transmission power associated with the first slot type. The communications manager 620 is capable of, configured to, or operable to support a means for transmitting, at a second slot associated with a second slot type that is different from the first slot type, a second RACH repetition in accordance with a second transmission power associated with the second slot type, where the second transmission power is based on the power offset being applied to the first transmission power.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, more efficient utilization of communication resources, reduced RACH latency, increased efficiency for initial access, and improved integration of half-duplex and full-duplex capabilities.

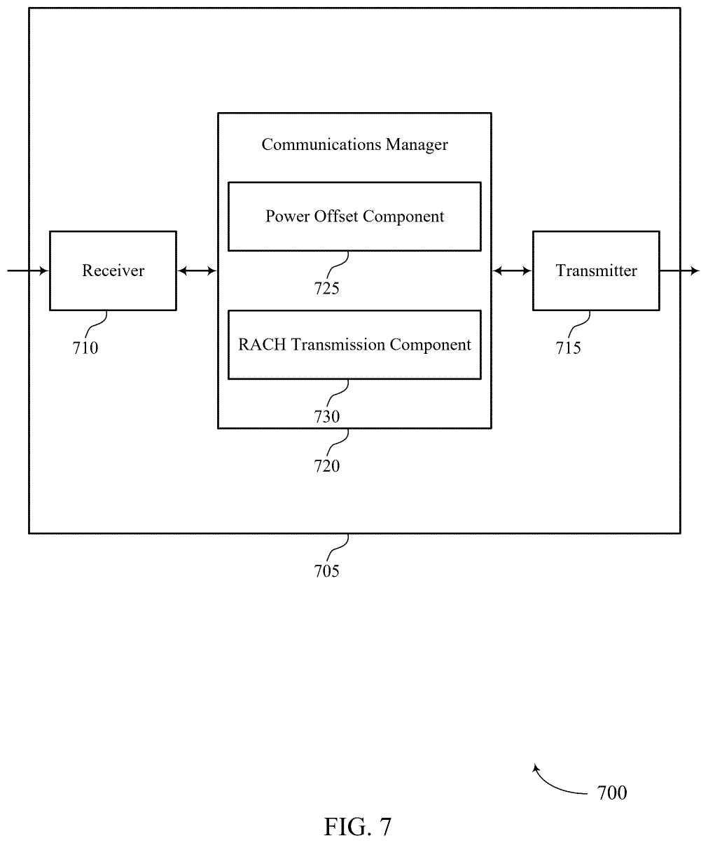

FIG. 7 shows a block diagram 700 of a device 705 that supports power control techniques for RACH repetitions in full duplex networks in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to power control techniques for RACH repetitions in full duplex networks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to power control techniques for RACH repetitions in full duplex networks). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of power control techniques for RACH repetitions in full duplex networks as described herein. For example, the communications manager 720 may include a power offset component 725 a RACH transmission component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The power offset component 725 is capable of, configured to, or operable to support a means for receiving one or more messages that include an indication of a power offset to apply to one or more transmission powers associated with RACH communications in one or more slot types. The RACH transmission component 730 is capable of, configured to, or operable to support a means for transmitting, at a first slot associated with a first slot type, a first RACH repetition in accordance with a first transmission power associated with the first slot type. The RACH transmission component 730 is capable of, configured to, or operable to support a means for transmitting, at a second slot associated with a second slot type that is different from the first slot type, a second RACH repetition in accordance with a second transmission power associated with the second slot type, where the second transmission power is based on the power offset being applied to the first transmission power.

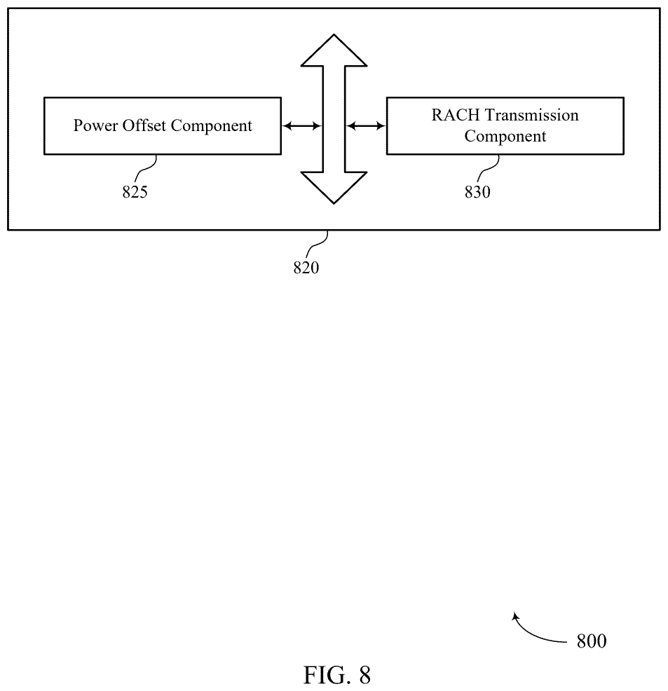

FIG. 8 shows a block diagram 800 of a communications manager 820 that supports power control techniques for RACH repetitions in full duplex networks in accordance with one or more aspects of the present disclosure. The communications manager 820 may be an example of aspects of a communications manager 620, a communications manager 720, or both, as described herein. The communications manager 820, or various components thereof, may be an example of means for performing various aspects of power control techniques for RACH repetitions in full duplex networks as described herein. For example, the communications manager 820 may include a power offset component 825 a RACH transmission component 830, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The power offset component 825 is capable of, configured to, or operable to support a means for receiving one or more messages that include an indication of a power offset to apply to one or more transmission powers associated with RACH communications in one or more slot types. The RACH transmission component 830 is capable of, configured to, or operable to support a means for transmitting, at a first slot associated with a first slot type, a first RACH repetition in accordance with a first transmission power associated with the first slot type. In some examples, the RACH transmission component 830 is capable of, configured to, or operable to support a means for transmitting, at a second slot associated with a second slot type that is different from the first slot type, a second RACH repetition in accordance with a second transmission power associated with the second slot type, where the second transmission power is based on the power offset being applied to the first transmission power.

In some examples, to support receiving the one or more messages that include the indication of the power offset, the power offset component 825 is capable of, configured to, or operable to support a means for receiving the indication of the power offset to apply to the one or more transmission powers via a SIB message, a RRC message, or both. In some examples, the power offset being applied to the first transmission power includes a fixed power offset value. In some examples, the first transmission power is less than or equal to a first maximum transmission power associated with the first slot type, and the second transmission power is less than or equal to a second maximum transmission power associated with the second slot type.

In some examples, the first transmission power is based on a maximum transmission power associated with the first slot type, a number of RACH repetitions transmitted by the UE, and a pathloss factor. In some examples, the second transmission power is based on the maximum transmission power associated with the first slot type, the number of RACH repetitions transmitted by the UE, the pathloss factor, and the power offset.

In some examples, a value of the power offset applied to the first transmission power is based on a total quantity of RACH repetitions associated with both the first slot type and the second slot type, a quantity of RACH repetitions allocated to the first slot type, a quantity of RACH repetitions allocated to the second slot type, a RSRP range associated with a received synchronization signal block, or any combination thereof.

In some examples, the power offset component 825 is capable of, configured to, or operable to support a means for calculating a value of the power offset in accordance with an initial offset value and a slope value multiplied by a quantity of RACH repetitions. In some examples, the power offset component 825 is capable of, configured to, or operable to support a means for adjusting the first transmission power to be within a threshold transmission power, where the threshold transmission power includes a maximum transmission power of the second slot type plus the power offset.

In some examples, the RACH transmission component 830 is capable of, configured to, or operable to support a means for transmitting, at a third slot associated with the first slot type, the second RACH repetition based on a maximum power being reached for the second RACH repetition in the second slot. In some examples, the RACH transmission component 830 is capable of, configured to, or operable to support a means for transmitting, at a third slot associated with the second slot type, a third RACH repetition based on a power restriction being reached for the first slot. In some examples, the RACH transmission component 830 is capable of, configured to, or operable to support a means for increasing a repetition number associated with the RACH communications based on a power restriction being reached for the first slot or the second slot.

In some examples, the first RACH repetition and the second RACH repetition include at least a portion of a repetition group, and the RACH transmission component 830 is capable of, configured to, or operable to support a means for transmitting each RACH repetition of the repetition group in accordance with a common transmission power, where the common transmission power is equal to a minimum transmission power between the first transmission power and the second transmission power.

In some examples, the first slot type includes a half-duplex slot, and the second slot type includes a subband full-duplex slot, or the first slot type includes a subband full duplex slot and the second slot type includes a half-duplex slot.

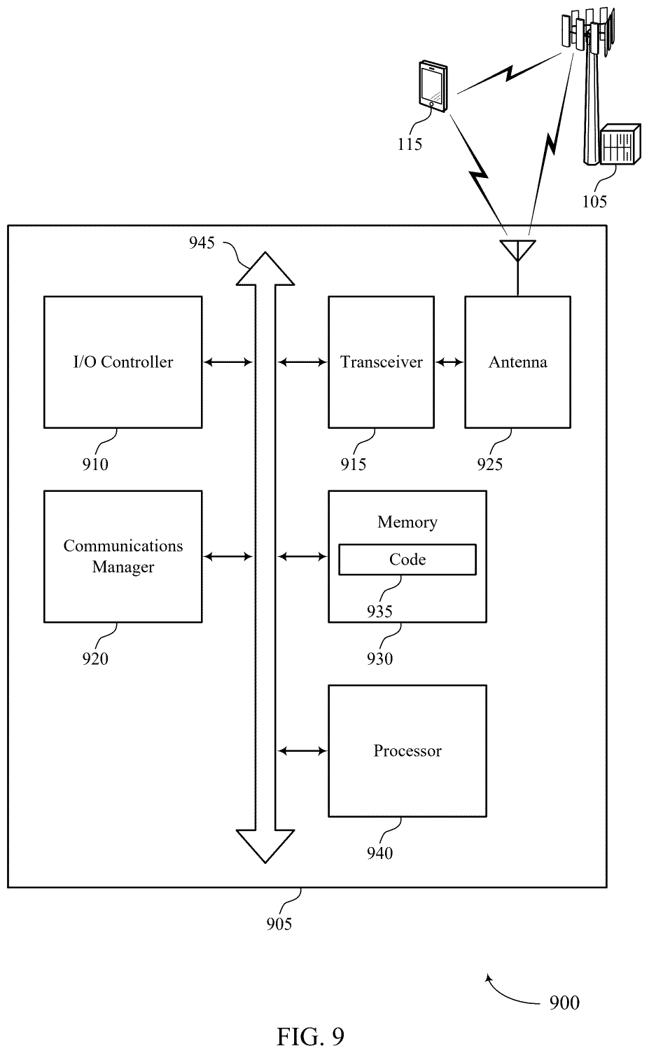

FIG. 9 shows a diagram of a system 900 including a device 905 that supports power control techniques for RACH repetitions in full duplex networks in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting power control techniques for RACH repetitions in full duplex networks). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving one or more messages that include an indication of a power offset to apply to one or more transmission powers associated with RACH communications in one or more slot types. The communications manager 920 is capable of, configured to, or operable to support a means for transmitting, at a first slot associated with a first slot type, a first RACH repetition in accordance with a first transmission power associated with the first slot type. The communications manager 920 is capable of, configured to, or operable to support a means for transmitting, at a second slot associated with a second slot type that is different from the first slot type, a second RACH repetition in accordance with a second transmission power associated with the second slot type, where the second transmission power is based on the power offset being applied to the first transmission power.

By including or configuring the communications manager 920 in accordance with examples as described herein, the device 905 may support techniques for improved communication reliability, reduced latency including reduced latency associated with RACH procedures, more efficient utilization of communication resources including TDD and SBFD resources, improved coordination between devices, and improved efficiency for transmission of RACH repetitions.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of power control techniques for RACH repetitions in full duplex networks as described herein, or the at least one processor 940 and the at least one memory 930 may be otherwise configured to, individually or collectively, perform or support such operations.

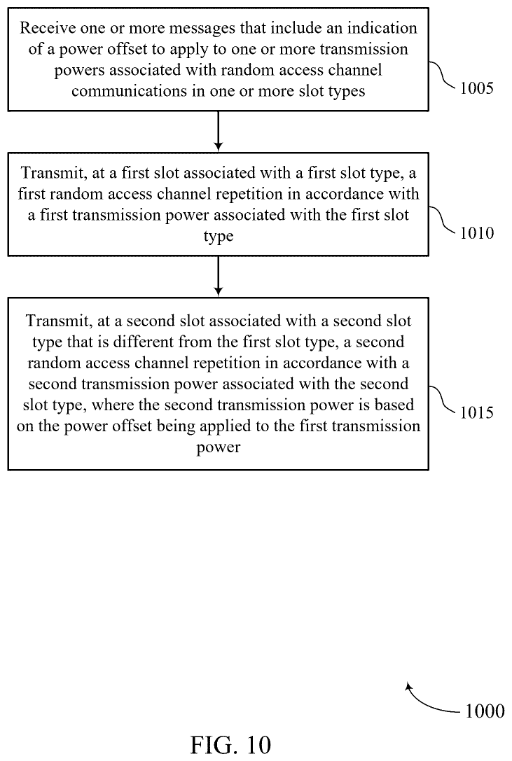

FIG. 10 shows a flowchart illustrating a method 1000 that supports power control techniques for RACH repetitions in full duplex networks in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving one or more messages that include an indication of a power offset to apply to one or more transmission powers associated with RACH communications in one or more slot types. The operations of 1005 may be performed in accordance with examples as disclosed herein. In some examples, aspects of the operations of 1005 may be performed by a power offset component 825 as described with reference to FIG. 8.

At 1010, the method may include transmitting, at a first slot associated with a first slot type, a first RACH repetition in accordance with a first transmission power associated with the first slot type. The operations of 1010 may be performed in accordance with examples as disclosed herein. In some examples, aspects of the operations of 1010 may be performed by a RACH transmission component 830 as described with reference to FIG. 8.

At 1015, the method may include transmitting, at a second slot associated with a second slot type that is different from the first slot type, a second RACH repetition in accordance with a second transmission power associated with the second slot type, where the second transmission power is based on the power offset being applied to the first transmission power. The operations of 1015 may be performed in accordance with examples as disclosed herein. In some examples, aspects of the operations of 1015 may be performed by a RACH transmission component 830 as described with reference to FIG. 8.

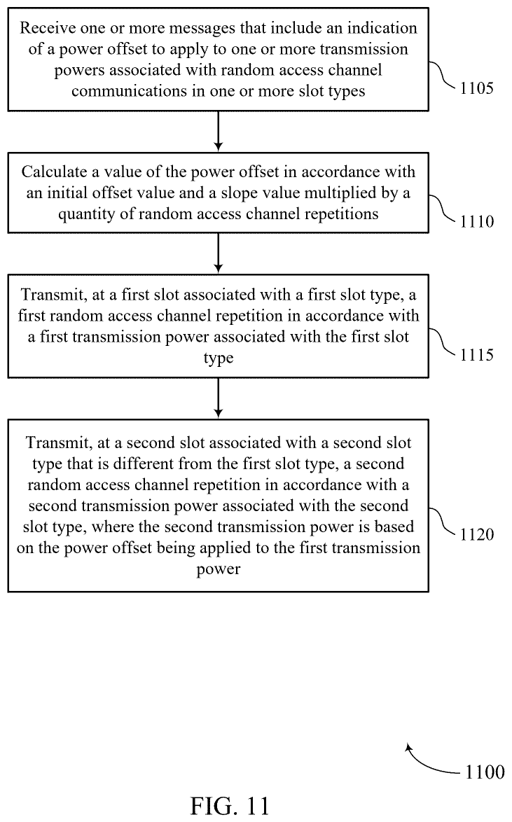

FIG. 11 shows a flowchart illustrating a method 1100 that supports power control techniques for RACH repetitions in full duplex networks in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving one or more messages that include an indication of a power offset to apply to one or more transmission powers associated with RACH communications in one or more slot types. The operations of 1105 may be performed in accordance with examples as disclosed herein. In some examples, aspects of the operations of 1105 may be performed by a power offset component 825 as described with reference to FIG. 8.

At 1110, the method may include calculating a value of the power offset in accordance with an initial offset value and a slope value multiplied by a quantity of RACH repetitions. The operations of 1110 may be performed in accordance with examples as disclosed herein. In some examples, aspects of the operations of 1110 may be performed by a power offset component 825 as described with reference to FIG. 8.

At 1115, the method may include transmitting, at a first slot associated with a first slot type, a first RACH repetition in accordance with a first transmission power associated with the first slot type. The operations of 1115 may be performed in accordance with examples as disclosed herein. In some examples, aspects of the operations of 1115 may be performed by a RACH transmission component 830 as described with reference to FIG. 8.

At 1120, the method may include transmitting, at a second slot associated with a second slot type that is different from the first slot type, a second RACH repetition in accordance with a second transmission power associated with the second slot type, where the second transmission power is based on the power offset being applied to the first transmission power. The operations of 1120 may be performed in accordance with examples as disclosed herein. In some examples, aspects of the operations of 1120 may be performed by a RACH transmission component 830 as described with reference to FIG. 8.

The following provides an overview of aspects of the present disclosure:

Aspect 1: A method for wireless communications at a UE, comprising: receiving one or more messages that include an indication of a power offset to apply to one or more transmission powers associated with RACH communications in one or more slot types; transmitting, at a first slot associated with a first slot type, a first RACH repetition in accordance with a first transmission power associated with the first slot type; and transmitting, at a second slot associated with a second slot type that is different from the first slot type, a second RACH repetition in accordance with a second transmission power associated with the second slot type, wherein the second transmission power is based at least in part on the power offset being applied to the first transmission power.

Aspect 2: The method of aspect 1, wherein receiving the one or more messages that include the indication of the power offset comprises: receiving the indication of the power offset to apply to the one or more transmission powers via a system information block message, an RRC message, or both.

Aspect 3: The method of any of aspects 1 through 2, wherein the power offset being applied to the first transmission power comprises a fixed power offset value.

Aspect 4: The method of any of aspects 1 through 3, wherein the first transmission power is less than or equal to a first maximum transmission power associated with the first slot type, and the second transmission power is less than or equal to a second maximum transmission power associated with the second slot type.

Aspect 5: The method of any of aspects 1 through 4, wherein the first transmission power is based at least in part on a maximum transmission power associated with the first slot type, a number of RACH repetitions transmitted by the UE, and a pathloss factor, and the second transmission power is based at least in part on the maximum transmission power associated with the first slot type, the number of RACH repetitions transmitted by the UE, the pathloss factor, and the power offset.

Aspect 6: The method of any of aspects 1 through 5, wherein a value of the power offset applied to the first transmission power is based at least in part on a total quantity of RACH repetitions associated with both the first slot type and the second slot type, a quantity of RACH repetitions allocated to the first slot type, a quantity of RACH repetitions allocated to the second slot type, a reference signal receive power range associated with a received SSB, or any combination thereof.

Aspect 7: The method of any of aspects 1 through 6, further comprising: calculating a value of the power offset in accordance with an initial offset value and a slope value multiplied by a quantity of RACH repetitions.

Aspect 8: The method of any of aspects 1 through 7, further comprising: adjusting the first transmission power to be within a threshold transmission power, wherein the threshold transmission power comprises a maximum transmission power of the second slot type plus the power offset.

Aspect 9: The method of any of aspects 1 through 8, further comprising: transmitting, at a third slot associated with the first slot type, the second RACH repetition based at least in part on a maximum power being reached for the second RACH repetition in the second slot.

Aspect 10: The method of any of aspects 1 through 9, further comprising: transmitting, at a third slot associated with the second slot type, a third RACH repetition based at least in part on a power restriction being reached for the first slot.

Aspect 11: The method of any of aspects 1 through 10, further comprising: increasing a repetition number associated with the RACH communications based at least in part on a power restriction being reached for the first slot or the second slot.

Aspect 12: The method of any of aspects 1 through 11, wherein the first RACH repetition and the second RACH repetition comprise at least a portion of a repetition group, the method further comprising: transmitting each RACH repetition of the repetition group in accordance with a common transmission power, wherein the common transmission power is equal to a minimum transmission power between the first transmission power and the second transmission power.

Aspect 13: The method of any of aspects 1 through 12, wherein the first slot type comprises a half-duplex slot and the second slot type comprises a SBFD slot, or the first slot type comprises a SBFD slot and the second slot type comprises a half-duplex slot.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more messages that include an indication of a power offset to apply to one or more transmission powers associated with random access channel communications in one or more slot types;
transmit, at a first slot associated with a first slot type, a first random access channel repetition in accordance with a first transmission power associated with the first slot type; and
transmit, at a second slot associated with a second slot type that is different from the first slot type, a second random access channel repetition in accordance with a second transmission power associated with the second slot type, wherein the second transmission power is based at least in part on the power offset being applied to the first transmission power.

2. The UE of claim 1, wherein, to receive the one or more messages that include the indication of the power offset, the one or more processors are individually or collectively operable to execute the code to cause the UE to:
receive the indication of the power offset to apply to the one or more transmission powers via a system information block message, a radio resource control message, or both.

3. The UE of claim 1, wherein the power offset being applied to the first transmission power comprises a fixed power offset value.

4. The UE of claim 1, wherein the first transmission power is less than or equal to a first maximum transmission power associated with the first slot type, and the second transmission power is less than or equal to a second maximum transmission power associated with the second slot type.

5. The UE of claim 1, wherein the first transmission power is based at least in part on a maximum transmission power associated with the first slot type, a number of random access channel repetitions transmitted by the UE, and a pathloss factor, and the second transmission power is based at least in part on the maximum transmission power associated with the first slot type, the number of random access channel repetitions transmitted by the UE, the pathloss factor, and the power offset.

6. The UE of claim 1, wherein a value of the power offset applied to the first transmission power is based at least in part on a total quantity of random access channel repetitions associated with both the first slot type and the second slot type, a quantity of random access channel repetitions allocated to the first slot type, a quantity of random access channel repetitions allocated to the second slot type, a reference signal receive power range associated with a received synchronization signal block, or any combination thereof.

7. The UE of claim 1, wherein the one or more processors are individually or collectively further operable to execute the code to cause the UE to:
calculate a value of the power offset in accordance with an initial offset value and a slope value multiplied by a quantity of random access channel repetitions.

8. The UE of claim 1, wherein the one or more processors are individually or collectively further operable to execute the code to cause the UE to:
adjust the first transmission power to be within a threshold transmission power, wherein the threshold transmission power comprises a maximum transmission power of the second slot type plus the power offset.

9. The UE of claim 1, wherein the one or more processors are individually or collectively further operable to execute the code to cause the UE to:
transmit, at a third slot associated with the first slot type, the second random access channel repetition based at least in part on a maximum power being reached for the second random access channel repetition in the second slot.

10. The UE of claim 1, wherein the one or more processors are individually or collectively further operable to execute the code to cause the UE to:
transmit, at a third slot associated with the second slot type, a third random access channel repetition based at least in part on a power restriction being reached for the first slot.

11. The UE of claim 1, wherein the one or more processors are individually or collectively further operable to execute the code to cause the UE to:
increase a repetition number associated with the random access channel communications based at least in part on a power restriction being reached for the first slot or the second slot.

12. The UE of claim 1, wherein the first random access channel repetition and the second random access channel repetition comprise at least a portion of a repetition group, and the one or more processors are individually or collectively further operable to execute the code to cause the UE to:
transmit each random access channel repetition of the repetition group in accordance with a common transmission power, wherein the common transmission power is equal to a minimum transmission power between the first transmission power and the second transmission power.

13. The UE of claim 1, wherein the first slot type comprises a half-duplex slot and the second slot type comprises a subband full-duplex slot, or the first slot type comprises a subband full duplex slot and the second slot type comprises a half-duplex slot.

14. A method for wireless communications at a user equipment (UE), comprising:
receiving one or more messages that include an indication of a power offset to apply to one or more transmission powers associated with random access channel communications in one or more slot types;
transmitting, at a first slot associated with a first slot type, a first random access channel repetition in accordance with a first transmission power associated with the first slot type; and
transmitting, at a second slot associated with a second slot type that is different from the first slot type, a second random access channel repetition in accordance with a second transmission power associated with the second slot type, wherein the second transmission power is based at least in part on the power offset being applied to the first transmission power.

15. The method of claim 14, wherein receiving the one or more messages that include the indication of the power offset comprises:
receiving the indication of the power offset to apply to the one or more transmission powers via a system information block message, a radio resource control message, or both.

16. The method of claim 14, wherein the first transmission power is less than or equal to a first maximum transmission power associated with the first slot type, and the second transmission power is less than or equal to a second maximum transmission power associated with the second slot type.

17. The method of claim 14, wherein the first transmission power is based at least in part on a maximum transmission power associated with the first slot type, a number of random access channel repetitions transmitted by the UE, and a pathloss factor, and the second transmission power is based at least in part on the maximum transmission power associated with the first slot type, the number of random access channel repetitions transmitted by the UE, the pathloss factor, and the power offset.

18. The method of claim 14, wherein a value of the power offset applied to the first transmission power is based at least in part on a total quantity of random access channel repetitions associated with both the first slot type and the second slot type, a quantity of random access channel repetitions allocated to the first slot type, a quantity of random access channel repetitions allocated to the second slot type, a reference signal receive power range associated with a received synchronization signal block, or any combination thereof.

19. The method of claim 14, wherein the first random access channel repetition and the second random access channel repetition comprise at least a portion of a repetition group, the method further comprising:
transmitting each random access channel repetition of the repetition group in accordance with a common transmission power, wherein the common transmission power is equal to a minimum transmission power between the first transmission power and the second transmission power.

20. A user equipment (UE) for wireless communications, comprising:
means for receiving one or more messages that include an indication of a power offset to apply to one or more transmission powers associated with random access channel communications in one or more slot types;
means for transmitting, at a first slot associated with a first slot type, a first random access channel repetition in accordance with a first transmission power associated with the first slot type; and
means for transmitting, at a second slot associated with a second slot type that is different from the first slot type, a second random access channel repetition in accordance with a second transmission power associated with the second slot type, wherein the second transmission power is based at least in part on the power offset being applied to the first transmission power.
